(19) United States
(12) Patent Application Publication
(10) Pub. No.: US 2013/0316768 A1
(43) Pub. Date: Nov. 28, 2013

(54) SYSTEM FOR ENABLING UNINTENTIONAL DIRECT OR REMOTE CELLULAR TELEPHONE SWITCH-OFF

(71) Applicant: Edilberto Acacio Da Silva, Ribeirão, Preto-SP (BR)

(72) Inventor: Edilberto Acacio Da Silva, Ribeirão, Preto-SP (BR)

(21) Appl. No.: 13/984,177

(22) PCT Filed: Oct. 26, 2011
(86) PCT No.: PCT/BR2011/000398

§ 371 Date: Aug. 7, 2013

(30) Foreign Application Priority Data
Feb. 7, 2011 (BR) PI1100288-3

(51) Int. Cl. H04M 19/08

(52) U.S. Cl. CPC H04M 19/08
USPC 455/573

(57) ABSTRACT

The present invention is a system for turning off involuntarily, physically or remotely a cellular telephone, represented by an inventive solution in the industry and commerce of telephone devices, mainly mobile telephones, the object of which is that the cellular device (4) must always remain “off” when connected to the battery charger (2), or on the base (11) of a wireless telephone charger, irrespective of the fact that is connected to the power supply (1) or not, thus eliminating the risks to the safety of the user (5), mainly when the battery recharge operation (8) takes place in a climatic condition of high power discharge, and for such purpose it will be enough to keep the pin (3) of the battery charger (2) connected to the connecting opening (4b), so that the “turn on” function of the on/off switch (4a) is deactivated while said connection is carried out, and additionally a remote safety system is provided, which system is turned off automatically when an adverse climatic condition is detected, independently of the user's proactive or reactive action, in such a way that when the cellular device (4) is in normal use, that is, removed from the charger, so that the users do not attract fatal thunderbolts.

### FIELD OF APPLICATION

The patent referred to in the title hereinabove object of the present disclosure and claims hereinbelow is an inventive solution in the field of application dictated by industry and commerce of telephone devices, mainly mobile telephones and specifically those devices popularly known as “cell phones.”

### DISCLOSURE OF THE INVENTION

Assuming the industry and commerce of the “cell phones” as a parameter, the applicant identified the need to add value to the already consecrated multi-functional concept of this type of product, a need generated by the necessity to safeguard the user when he/she uses same, particularly when the device exhibits the following conditions:

1. when its power source (battery) is recharged;
2. under normal use conditions, even when disconnected from the battery charger.

In other words, there is a crying need to set a limit to the condition under which a cellular device is used, the safety of which is presumed and/or omitted by the manufacturers and guaranteed only when it works autonomously, that is, only activated through the exclusive use of its battery in a non-charging condition.

In view of the above, the applicant has devised the present invention as a device that turns off fully and immediately a cellular device whenever its “charging point” or access to wired communication with peripheral devices receives the novel “disabling device”, such as a differentiated “pin”.

The possibility of a system that can turn off remotely the cellular device whenever the user is in a hostile climate area has also been considered.

Thus, it may be said that the device to “turn off involuntary, physically or remotely a cellular device” is provided with a novel feature associated to inventiveness, since it is neither obvious nor evident in other cellular devices (that are mandatorily accompanied by a battery charger) known in the state of the art, and is also provided with industrial applicability, thus satisfying the patentability requirements, mainly as a patent, according to the provisions of articles 8 and 13 of Law 9.279.

### BACKGROUND OF THE INVENTION

In order to provide evidence to the concept presented in the introduction, a brief explanation on the state of the art for mobile telephones will be presented now, so that one skilled in the art can recognize that besides providing excellence in its proposal to provide multimedia communication, the limiting aspects thereof can be recognized by the technical considerations of the applicant, so that the advantages added with the introduction of the novel device that fully deactivates the cellular device object of the present claims may be disclosed hereinbelow.

Concept of the cellular device: it is an electromagnetic communication device that makes it possible to transmit voice and data bidirectionally that can be used in a geographic area that is divided into cells (the reason of the cellular nomenclature), each one which served by a transmitter/receiver. The cellular telephone was invented in 1947 by Bell Laboratory, U.S.

Technologies embedded in the cellular device: they are co-different technologies for transmitting electromagnetic waves to mobile telephones, based on the compression of the information or distribution thereof.

The first generation (1G) was analogical and developed in the early 80's with the NMT and AMPS systems. In the second generation (2G), the technology turned out to be digital, developed in the late 80's and in the early 90's: GSM, CDMA and TDMA.

A second-and-a-half generation (2.5G) is also considered, which is an evolution of the 2G, with significant improvements in the ability to transmit data and the adoption of package technology and not circuit commutation any longer, present in the GPRS, EDGE, HSCSD and 1xRTT technologies.

In the late 90's, the mobile telephone achieved its third generation (3G), also digital, but provided with more resources and developed since the late 90's, such as UMTS and EVDO; and third-and-a-half generation (3.5G), such as HSDPA, HSPA and HSUPA.

Finally, the industry of mobile telephones openly talks of the fourth generation 4G (fourth generation). On their turn, the analogous devices whose technology is based on radio waves were already used by the Chicago police in the thirties, among other technologies.

The cellular device as multimedia: the development of the technology embedded in the cellular devices allowed a number of resources to be added, such as camera, FM radio and

MP3 readers as time has elapsed. (3) Some telephones have an integrated hand computer—Palm or PocketPC—the so-called smartphones (from English “smart”, intelligent, “phone”, telephone). Its main characteristic is the possibility of installing programs that use the resources provided for in the device. Some examples are dictionaries, translators, games and e-mail clients. The mostly used operating systems are Symbian and Windows Mobile, but Linux has grown exponentially as well.

With the new third generation (3G) technologies that offer high speed data, it is possible to make real time video-conference calls, with the aid of new equipment with a front camera near the display.

On their turn, most of the new models are provided with some form of connection with other telephones—IrDA (infrared) or Bluetooth. Such technologies are mainly meant for sending data amongst telephones.

Briefly, nowadays the cell telephone is not a simple pocket telephone any longer. Cameras provided with 12.1 Mpx have already been launched in Europe, and in Brazil even up to 8.1 Mpx may be found, and those are higher resolutions than many digital cameras. The internet can already be accessed by Wi-Fi and broad band 3G and 4G in Japan.

On their turn, the cellular devices may be embedded with games with graphics that are compared to PSP videogame with a 3D quality. Screens that had four thousand colors in 2003 possess more than 16 million colors now. The sizes have also increased. Today the cellular phones have touch screens with up to 4 inches. In a few years the cellular phone will be our “Entertainment Center”.

The operational autonomy of a cellular device: in addition to the great jump in the data transmission and reception technology, another aspect considered in a mobile telephone device is its operational autonomy that has also experienced a great evolution in the last decades.

To be operational, a cellular device needs a power source, that on its turn is translated into the form of a battery.

However, the autonomy provided by the present batteries is a few hours only when not in use, and even more restricted when the cellular phone is in use.

Identification of the problem: a direct consequence of the technological evolution applied to cellular devices is that this device can be turned into a multimedia device, as evidenced in the previous paragraphs, what in turn has caused a drastic behavior change as regards the use of such a device.

While being used as a mere device to make and receive telephone calls, the metered time of use of same was restricted to at most a few hours per day.

With the advent of the multimedia functions embedded in the current cellular devices, its daily use under operational condition has jumped to many hours, the use of which is practically continuous by users of any age.

Autonomy x demand of operational use: in view of the fact that the autonomy of the batteries embedded in the cellular devices has not evolved at the same pace than the time of operational use of same, the indiscriminate use of such cellular devices has become trivial even when the battery is being recharged.

Thus, we usually see users connecting their cellular devices to battery chargers, which on their turn are connected to electric power networks available in the building they are located.

Risks to the safety of the user: the result of the uncontrolled demand for the use of the services and applications provided for in the cellular device is that the users do not wait for the effective charging of the battery of the device any longer, leaving same turned on while it is being recharged.

Besides forcing the operational structure of the battery, thus compromising its useful life, such practice brings about a number of risks to the health of the user, mainly when the system comprised of the electric power network—battery charger—cellular telephone—user is subject to the harmful effect of electric discharges from severe climatic conditions (such as for example, the high frequency of thunderbolts in the surrounding area).

In view of the fact that the system comprised of the electric power network—battery charger—cellular telephone—user is linear, an electric discharge in the beginning of same is transmitted with the same intensity to the body of the user, and thus it may cause from light injuries to death.

A relevant factor in all this condition of overcharge in the use of the devices associated to a condition that may lead to a risk caused by an electric discharge is the inertial behavior of the users in the maintenance of the cellular device directly connected to an electric power network, even under severe climatic conditions that suggest the eminent occurrence of overcharge on the system comprised of “electric power network—battery charger—cellular telephone—user”.

This condition, however, is not the only one that can be found, since people usually use the cellular telephone when it is not connected to the battery charger, that is, in condition of full use, because the users are not worried about the climatic conditions during its use, especially under adverse climatic conditions.

Briefly, it is the use of the cellular device that is connected or not to the battery charger when used under adverse conditions that creates a condition of serious risk to the health, and even to the life of the user, in view of the fact that the cellular device itself attracts electric discharges such as thunderbolts.

### Proposal of the Invention

1a. A system for turning off the cellular telephone while the battery is being charged: according to what was exposed in the Background of the Invention, the applicant has devised a “device for turning off involuntary a cellular telephone” that brings about the benefit of “breaking” the chain of the system comprised of “electric power network—battery charger—cellular telephone—user” specifically at the “user” end, thus making it feasible to provide singularly and exclusively the system comprised of “electric power network—battery charger—cellular telephone”.

Alternately, the applicant has devised the novel device for “deactivating the cellular device” when the system is only comprised of the “battery charger—cellular telephone” disconnected from the power source.

In view of the fact that there is a on/off switch for making the cellular device operational, an examination of its functionality makes it possible to say that such function is a “voluntary” nature function, that is, it requires the user to compress the on/off switch so that the device is effectively turned off (or turned on).

The present invention is a counterpoint to the concept of “voluntary” on/off function, where the novel device for deactivating the cellular device allows the “turn off” function to be “involuntarily” activated by the user whenever he/she inserts the “pin” of the battery charger into the input of the cellular device itself.

Finally, the application of the novel device for deactivating the cellular device is an efficient response to the inertial behavior of the user when he/she does not disconnect his/her cellular device while the battery is being charged, or else in any other condition where it is evident that there is an eminent danger to the health and welfare of the user.

1b. The distinctive characteristic: in order to turn the inventive activity into an “involuntary deactivation” of the cellular device, when connected to the battery charger, the device activates involuntarily the “turn off” function of the “on/off” switch through the compression of, for example, an “off button” in a position adjacent to the inner wall of the device housing, specifically lined up with the opening for connecting the energy cord of the battery charger.

Thus, when the cellular telephone is on and the user proceeds to insert the pin located at the end of the connecting cord of the battery charger into the connecting opening as this pin is moved to the end of its course, it starts to interact with the “off” button, thus activating the contact by means of an integrated circuit, for example, the “turn off” function of the on/off switch of the cellular device.

In addition, said contact disables temporarily the “turn on” function of this same “on/off” switch, preventing same from being “voluntarily” activated by the user while the pin is lodged in the connecting opening. The cellular telephone can only be activated again when the pin is removed from the connecting opening, in such a way that the “turn on” function of the “on/off” switch is reactivated.

On the other hand, in the present patent another alternative condition to deactivate temporarily and automatically the “turn on” function of this same “on/off” switch is provided, preventing same from being “voluntarily” activated by the user, to which end the cellular device, in addition to be provided with the traditional “pin” of the charger, should be optionally placed on a base/charger of a cellular telephone, said base/charger being wired/wireless and compatible with the cellular telephone, to charge the battery of the cellular telephone through an electric jack, electrostatic waves or other future technological ways.

2a. System for turning off remotely and involuntarily the cellular device when in adverse climatic conditions: wherein, irrespective of the “initiative” of the user, his/her cellular device will be turned off automatically when a remote signal indicative of an adverse climatic condition the user will be exposed to is received.

2b. Distinctive characteristic: in order to provide the inventive activity, a sensor “type” device or any technological system for receiving remote signals has been devised to be installed attached to the functional body of the cellular device, in order to allow communication through the transmission or reception of electromagnetic waves, via satellite, antennas and others (or the cellular device itself) to detect the presence of rain, thunderbolts or any adverse climatic situation in the area where the user is moving, or else under any other condition where it is found that there is an eminent danger to the health and welfare of the user, in such a way that when such adverse condition is identified the cellular device is turned off immediately, without the need of any intervention by the user, and the same is activated again only after such adverse condition is eliminated (such as thunderbolts and other dangerous conditions for the user in the area).

3. Conditions to alert the user:

In a first embodiment, to consolidate the condition of safe use of the cellular device, the user should be alerted by conventional means, such as “alert” or “prohibition/risks” instructions that may/must be shown in the device manual or affixed on the cellular telephone itself when it is being improperly used and connected to the battery charger (connected or not to the electric power source).

In addition, it also should be attached to the device and provided in the same cellular device instructions and operation manual stating that when there is an adverse climatic condition, the alert/prohibition/risks instructions should accompany the “cellular” product, alerting the user not to use the device that is connected to the charger or not.

### BRIEF DESCRIPTION OF THE DRAWINGS

To complement the present description of the specification in order to get a better understanding of the characteristics of the present invention, a set of drawings that show in an exemplified but not limited way a preferred embodiment for the “device to turn off” involuntarily a cellular device is provided that is not intended to limit the scope of the invention that is limited only to what is explicited in the set of claims, wherein:

FIG. 1 is a schematic representation of the operational support system of a cellular device;

FIG. 2 is a schematic representation of the operational support system of a cellular device, evidencing the condition of indiscriminate use of the cellular device even when its battery is being recharged;

FIG. 3 is a schematic representation of the operational support system of a cellular device, evidencing the new condition of “non-use” of the cellular device when its battery is being charged;

FIG. 4 is a schematic representation of the operational support system of a cellular device, evidencing the new condition of “non-use” of the cellular device, with the battery charger connected, but disconnected from the electric power source;

FIG. 5 is a representation of the physical connection of the cellular telephone and the battery charger to which a first embodiment of the “device for turning off involuntarily” a cellular telephone is embedded;

FIG. 5a is a schematic representation of the condition immediately preceding the activation of the “device for turning off involuntarily” a cellular telephone;

FIG. 5b is a schematic representation of the condition wherein the “device for turning off involuntarily” a cellular telephone is activated;

FIG. 5c is a schematic representation of the condition wherein the “device for turning off involuntary” a cellular telephone is deactivated;

FIG. 6a is a schematic representation of the operational support system of a cellular device, evidencing the new condition of “non-use” of the cellular device when placed on the cradle of the base of a wireless telephone, mainly before said cellular device is placed on the cradle of its base;

FIG. 6b is a schematic representation of the operational support system of a cellular device, evidencing the new condition of “non-use” of the cellular device when placed on the cradle of the base of a wireless device, mainly after said cellular device is placed on the cradle of its base;

FIG. 7 is a schematic representation of the automatic remote disconnecting system of the cellular device when the user enters an adverse climatic zone subject to electric discharges;

FIG. 8 is a illustrative representation of the recommendation/prohibition/risks and alerts not to use the cellular device in a normal use situation, or connected to the battery charger under an adverse climatic condition or not, to be affixed as a printed sticker on the back of the body of the cellular device; and

FIG. 9 is a illustrative representation of the recommendation/prohibition/risks and alerts not to use the cellular device when under an adverse climatic condition or when connected to the electric power charger affixed as a printed sticker to a page of the instructions manual for the use and care of the cellular device.

### DETAILED DESCRIPTION

The following detailed description should be read and interpreted with reference to the accompanying drawings, representing the preferred embodiments of the “system for turning off involuntarily, physically or remotely a cellular device”; not intended to limit the scope of the invention which is limited only by what is explicited in the set of claims.

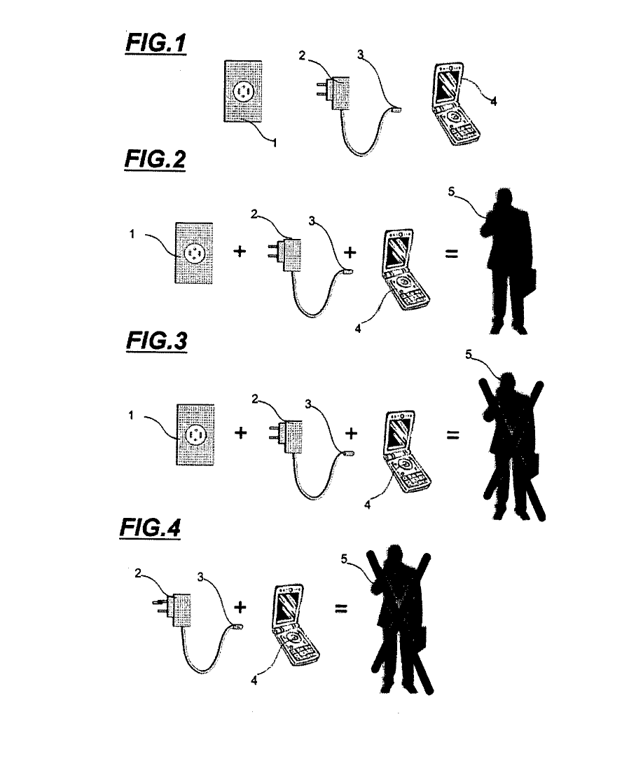

Technological grounds: firstly, to consolidate the understanding of what is disclosed and evidenced in the Background of the Invention, FIG. 1 shows the set of components required to support a cellular device, that is:
an electric power source (1);
a charger (2) with a connecting cord;
a contact pin (3) at the end of the connecting cord of the battery charger (2); and
a cellular device (4).

FIG. 2 depicts a conventional system comprised of a power source (1)+battery charger (2) with pin (3)+cellular telephone, the practical result of which reveals that in this conventional configuration the user (5) can make use of the cellular device (4) even when it is connected by means of the pin (3) to the battery charger (2) which on its turn is connected to the power source (1), and this condition may be dangerous to the health of the user in certain situations.

1. System for deactivating the cellular telephone while the battery is being charged: to solve this problem, the present “system for turning off involuntarily a cellular device” was devised, that is effective when the cellular device (4) is connected to the battery charger (2) that can be connected to the power source (1), see FIG. 3, or not connected, see FIG. 4.

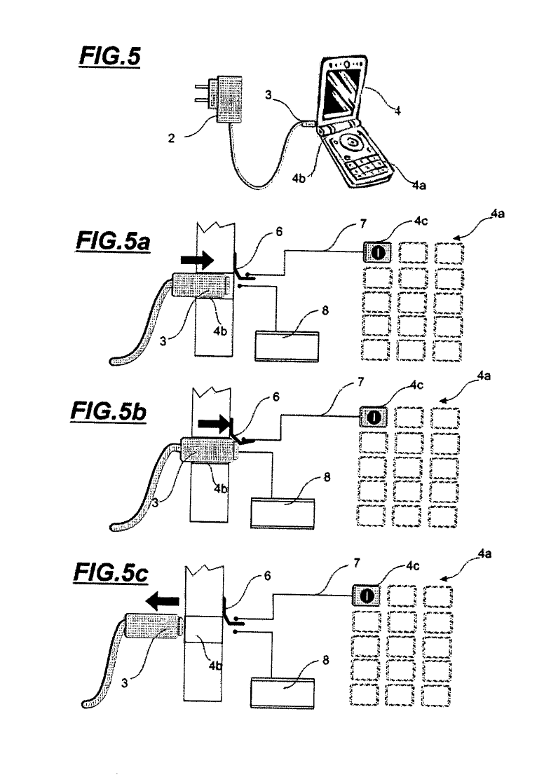

This “safety system” is embedded inside the cellular device (4), specifically as a “on/off switch” (or another future technological device) (6) disposed in a position adjacent to the inner wall of the cellular device (4) housing, specifically lined up with the connecting opening (4b) of the pin (3) defined at the end of the power cord of the battery charger (2), such as evidenced through FIG. 5a. On its turn, said on/off switch (6) is connected by means of an integrated circuit (7) to the “turn off” function of the on/off switch (4c) disposed on the keyboard (4a) of the cellular device, such as evidenced in FIGS. 5 and 5a.

Thus, when the cellular device (4) is on and the user (5) proceeds to introduce the pin (3) located at the end of the connecting cord of the battery charger (3) inside the connecting opening (4b) while said pin (3) is moved to the end of its course, it starts to interact with the “off” button (6) activating the contact by means of the integrated circuit (7), for example, the “turn off” function of the on/off switch (4c) of the cellular device (4a), such condition being evidenced through FIG. 5b.

A relevant fact is that the unknown device does not interfere with the effectiveness of the primary pin function (8), that is, provide contact in order to recharge the battery (8).

The cellular device (4) could only be activated again when the pin (3) is removed from the connecting opening (4b), so that the off button (6) is returned to its original resting position, eliminating the contact with the integrated circuit (7), thus reactivating the “turn on” function of the “on/off” switch (4c) so that the user can turn on his/her device and access all the functions thereof.

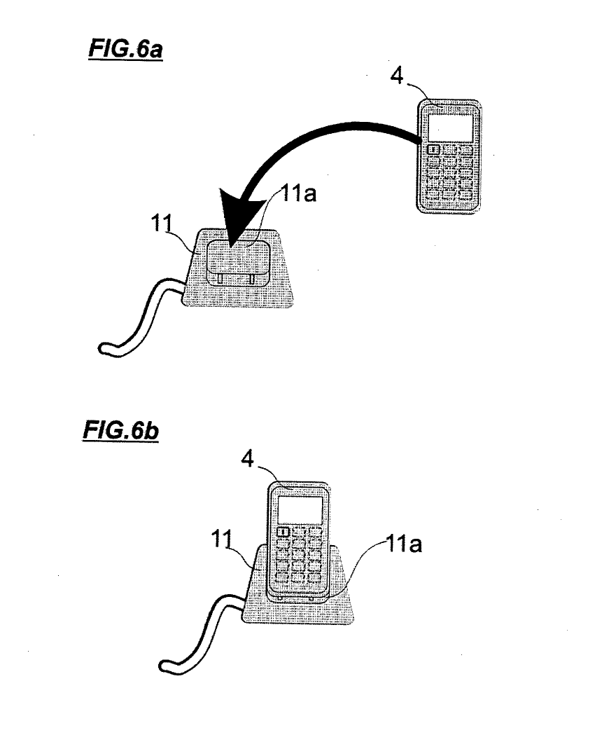

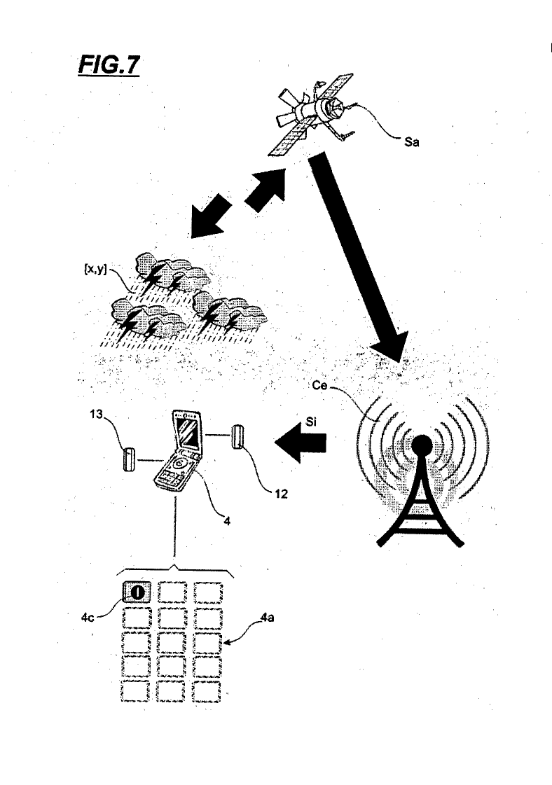

On the other hand, in a second embodiment of the invention, the device (4) will have its “turn off” function of the “on/off” switch (4c) of the cellular device (4a) activated when it rests on the cradle (11a) of the base (11) of the wireless telephone, as evidenced through FIGS. 6a and 6b, respectively.

2. Remote safety system: when the cellular device is in normal use, that is, disconnected from the charger, it is turned off automatically when an adverse climatic condition is detected so that the users do not attract fatal thunderbolts, and for such purpose is foreseen in the device (4) a sensor (12) that receives a remote signal (Si) that specifically turns off the device, from a climatic monitoring center (Ce) that will capture, via satellite (Sa), the adverse climatic condition in the location of the user (X,Y) which on its turn is tracked by a GPS type device also attached to the cellular device (4) in such a way that said signal (Sa) disables the “turn on” function of the “on/off” switch (4c), turning off the cellular device (4) itself automatically and independently of the intervention by the user.

Alternatively, said turn off signal (Si) could be sent/effected even by the mobile telephone operator hired by the user (5) that will cut off the signal/contact with the transmission tower of the cellular telephone (4), keeping same disabled until the risks of thunderbolts ceases.

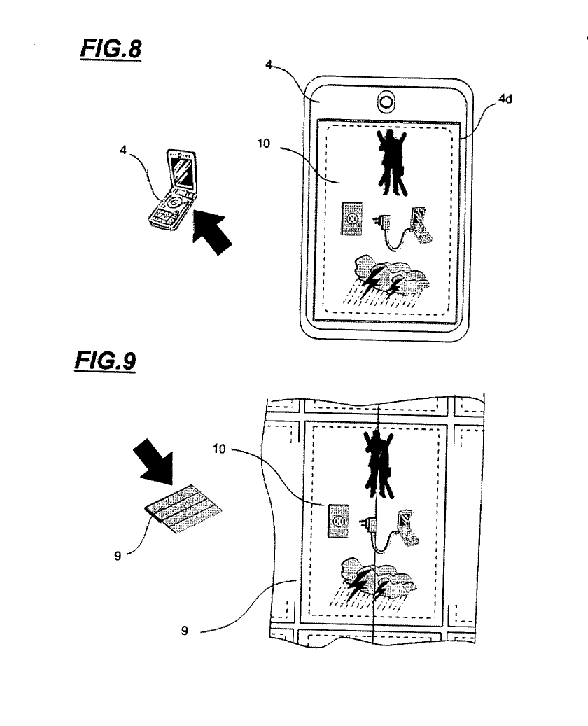

User alert conditions: the concept of the inventor is that in order to potentiate the imperative need of the proper safe use of the cellular telephone by the user his/her attention should be drawn by means of “alert signals” (10) that exhibit the prohibition to use the device (4) when its battery is being charged by the charger (2), wherein such alert signals (10) as prohibition, alert, risks and the like should be affixed on the back (4d) of the body (4a) of the cellular device (4), see FIG. 8, and also alternatively it should be provided as an illustrative drawing in the instructions manual (9), see FIG. 9.

The embodiment described in this constructive detailing topic of the invention is provided only for the sake of example. Changes, modifications and variations can be carried out through any other particular constructive embodiment by those skilled in the art without, however, departing from the object disclosed in the application that is exclusively defined by the attached claims.

According to what was described and illustrated above, it can be seen that the “SYSTEM FOR TURNING OFF INVOLUNTARILY, PHYSICALLY OR REMOTELY A CELLULAR TELEPHONE” claimed hereinbelow fits into the guidelines that govern the patent in the light of the Industrial Property Law, thus deserving the respective benefit as a consequence thereof.

1. A system for turning off involuntarily, physically or remotely a cellular telephone, wherein a typical system that keeps the “functional” condition of a cellular device (4) is formed by a power supply (1) to which a battery charger (2) is connected and on its turn is provided with a pin (3) at the end of the connecting cord that is connected to the cellular device (4) and has embedded therein a device is characterized by being assembled inside the cellular device (4) as a “on/off switch” (6) disposed in a position adjacent to the inner wall of the housing of the cellular device (4), lined up with the connecting opening (4b) of the connecting pin (3), wherein the “on/off switch” (6) is connected by means of an integrated circuit (7) to the “turn off” function of the on/off switch (4c) disposed on the keyboard (4a) of the cellular device.

2. The system for turning off involuntarily, physically or remotely a cellular telephone, according to claim 1, wherein in order that the cellular device (4) may have its “turn off” function deactivated the device, it is characterized by the pin (3) is inserted into the connecting opening (4b) as far as the end of its course and interferes with the “turn off” button (6) that closes the integrated circuit (7) connected to the “turn off” function of the on/off switch (4c) of the cellular device (4a) and deactivates the “turn on” function of the same switch.

3. A system for turning off involuntarily, physically or remotely a cellular telephone, according to claims 1 and 2, wherein while the cellular telephone (4) has the pin (3) connected to the connecting opening (4b), it is characterized by the “turn off” function remains deactivated and the “turn on” function remains activated.

4. A system for turning off involuntarily, physically or remotely a cellular telephone, according to claim 3, wherein the condition of “turn off” function remains activated and the “turn on” function remains deactivated, it is characterized by said condition is kept with the charger (2) connected or not to the power supply (1).

5. A system for turning off involuntarily, physically or remotely a cellular telephone, wherein in a second embodiment of the device where the condition of “turn off” function activated and the “turn on” function deactivated, it is characterized by the body (4a) of the cellular telephone rests on the cradle (11a) of the base (11) of the wireless telephone charger.

6. A device for turning off involuntarily, physically or remotely a cellular telephone, wherein in order that a cellular device (4) may be turned off remotely and involuntarily, that is, independently of the action of the user, a remote safety system is provided, characterized by the cellular device (4) has embedded therein a sensor (12) that receives a remote signal (Si) that specifically deactivates the device, from a climatic monitoring center (Ce) that captures, via satellite (Sa), the adverse climatic condition in the location of the user (X,Y), that on its turn is tracked by a GPS type device also attached to the cellular device (4), in such a way that said signal (Si) deactivates the “turn on” function of the “turn on/off” switch (4c), deactivating the cellular device (4) itself.

7. A system for turning off involuntarily, physically or remotely a cellular telephone, wherein, alternatively, in order to deactivate the cellular device (4) it is characterized by the turn off signal (Si) is sent/effected by the mobile telephone operator hired by the user (5) that will cut off the signal/contact with the transmission tower of the cellular telephone (4).
